(19) United States
(12) Patent Application Publication
(10) Pub. No.: US 2019/0261767 A1
(43) Pub. Date: Aug. 29, 2019

(54) CONFIGURABLE PERSONAL WASHING DEVICE

(71) Applicant: David Champagne, Britton, MI (US)

(72) Inventor: David Champagne, Britton, MI (US)

(21) Appl. No.: 16/283,288

(22) Filed: Feb. 22, 2019

Related U.S. Application Data
(60) Provisional application No. 62/634,972, filed on Feb. 26, 2018.
(60) Provisional application No. 62/714,508, filed on Aug. 3, 2018.

(51) Int. Cl. A46B 5/00; A46B 11/00; A46B 9/00; A46B 7/04; B25G 1/06

(52) U.S. Cl. CPC A46B 5/0058; A46B 11/002; A46B 9/005; A46B 5/007; B25G 1/102; A46B 7/046; B25G 1/06; A46B 2200/1006; A46B 2200/1046; A46B 5/0095

(57) ABSTRACT

A configurable personal washing device includes a central portion, a handle portion, a washing end portion, a first rotating joint connecting the central portion to the handle portion, and a second rotating joint connecting the central portion to the washing end portion. The first rotating joint and the second rotating joint are configured to permit selection between a first, curved state, a second partially extended state, and a third, fully extended state.

### CROSS REFERENCE TO RELATED APPLICATIONS

This disclosure claims the benefit of U.S. Provisional Application No. 62/634,972 filed on Feb. 26, 2018 and of U.S. Provisional Application No. 62,714,508 filed on Aug. 3, 2018, both of which are hereby incorporated by reference.

### TECHNICAL FIELD

This disclosure is related to a device used in personal hygiene, in particular, to a brush that can be configured into a number of various states to aid in reaching every area of the body.

### BACKGROUND

The statements in this section merely provide background information related to the present disclosure. Accordingly, such statements are not intended to constitute an admission of prior art.

People use brushes or handle loofahs to scrub various parts of the body during bathing. However, not everyone is able to easily reach every part of the body. Some people have injured shoulders or have lost flexibility do to age. Other people have injured backs or limited flexibility in their backs. Even brushes with straight handles, while extending the reach of the user, still can require that the arm of the user stretch into an awkward position or that the back of the user twist significantly.

Brushes with curved handles can reach in some of the necessary areas to be cleaned. However, most people cannot keep a multitude of brushes and loofahs within a bathing area. If four different shapes of handles are required to wash the person's body, keep four brush handles in the bathtub can be not possible due to lack of space in and around the bathtub.

### SUMMARY

A configurable personal washing device includes a central portion, a handle portion, a washing end portion, a first rotating joint connecting the central portion to the handle portion, and a second rotating joint connecting the central portion to the washing end portion. The first rotating joint and the second rotating joint are configured to permit selection between a first, curved state, a second partially extended state, and a third, fully extended state.

### BRIEF DESCRIPTION OF THE DRAWINGS

One or more embodiments will now be described, by way of example, with reference to the accompanying drawings, in which:

FIG. 1 illustrates an exemplary configurable personal washing device including at least one rotating joint permitting reconfiguration of the device, with the device being in a closed, curved state, in accordance with the present disclosure;

FIG. 2 illustrates the personal washing device of FIG. 1, with one of the rotating joints rotated, with the device being in a partially extended state, in accordance with the present disclosure;

FIG. 3 illustrates the personal washing device of FIG. 1, with both of the rotating joints rotated, with the device being in a fully extended state, in accordance with the present disclosure;

FIG. 4 illustrates a handle portion of the personal washing device of FIG. 1 in detail, illustrating components of one of the rotating joints, in accordance with the present disclosure;

FIG. 5 illustrates a central portion of the personal washing device of FIG. 1 in detail, illustrating components of one of the rotating joints, in accordance with the present disclosure;

FIG. 6 illustrates the central portion, a washing end portion, and a rotating joint there between of the personal washing device of FIG. 1, in accordance with the present disclosure;

FIG. 7 illustrates the central portion, washing end portion, and rotating joint of FIG. 6 in cross section, showing internal details of the rotating joint, in accordance with the present disclosure;

FIG. 8 illustrates an exemplary attachment end of the washing end portion, including a spring loaded attachment feature configured to selectively attach a washing attachment to the washing end portion, in accordance with the present disclosure;

FIG. 9 illustrates in top view a first exemplary washing attachment that can be attached to the personal washing device of FIG. 1, the attachment including a washing brush, in accordance with the present disclosure;

FIG. 10 illustrates the washing attachment of FIG. 9 in side view, in accordance with the present disclosure;

FIG. 11 illustrates in top view a second exemplary washing attachment that can be attached to the personal washing device of FIG. 1, the attachment including a lotion dispenser, in accordance with the present disclosure;

FIG. 12 illustrates the washing attachment of FIG. 11 in side view, in accordance with the present disclosure;

FIG. 13 illustrates in top view a third exemplary washing attachment that can be attached to the personal washing device of FIG. 1, the attachment including a scrubbing loofah, in accordance with the present disclosure;

FIG. 14 illustrates the washing attachment of FIG. 13 in side view, in accordance with the present disclosure;

FIG. 15 illustrates an exemplary embodiment of the central portion in cross section, illustrating optional gripping depressions formed in sides of the central portion, in accordance with the present disclosure;

FIG. 16 illustrates an exemplary alternative washing end portion, in accordance with the present disclosure; and

FIG. 17 illustrates an alternative embodiment of the central portion in cross section, in accordance with the present disclosure.

### DETAILED DESCRIPTION

An adjustable, configurable personal washing device with a handle and an exemplary washing attachment such as a brush, lotion dispending end, or loofah device is disclosed. As portions of the device are rotated relative to each other, the brush can be changed from a curved state to a fully extended state. In some embodiments, the device can be configured into a middle or partially extended state or middle states.

In a curved state, the overall shape of the brush is arcuate. In this shape, it can be easy for a person to hold a handle at a first end of the brush, let the arcuate center of the brush rest upon the shoulder of the user, and use the brush end portion at the second end of the brush to scrub the back of the user. Such a curved state can similarly be used along the side of the torso or abdomen to wash the back of the user without stressing the shoulders, back, or elbows of the user.

In an extended state, the overall shape of the brush is straight with small and alternating bends along the length of the brush. In such an elongated state, the brush can be used to wash the lower legs and feet of the user without stressing the shoulders, back, or elbows of the user.

In a middle state, with the brush facing sideways, the brush can be used to wash an inside or back of upper legs without stressing the shoulders, back, or elbows of the user.

The rotating joints of the device can be rotated and then locked into position. In one embodiment, the device includes bumps and mating cavities within the joint parts, with a rubberized band or spring device forcing the bumps into the cavities to lock the rotating joint into a selected orientation.

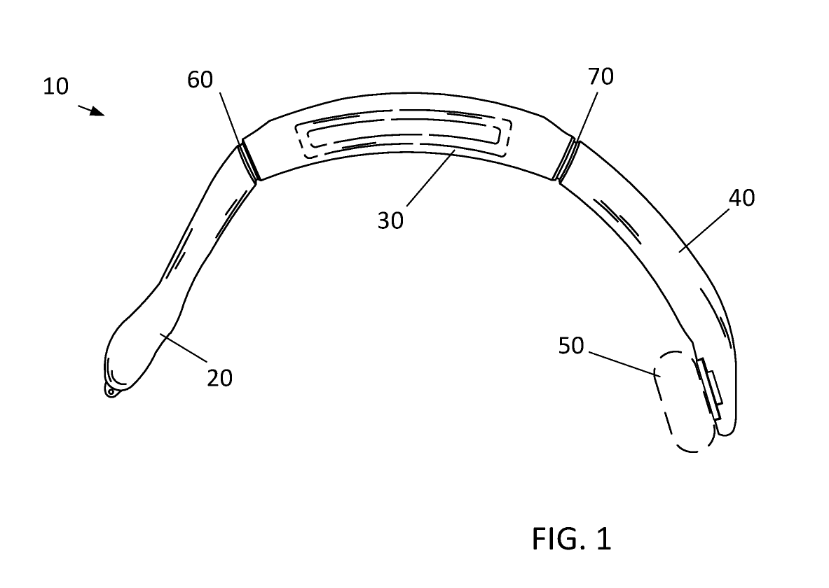

Referring now to the drawings, wherein the showings are for the purpose of illustrating certain exemplary embodiments only and not for the purpose of limiting the same, FIG. 1 illustrates an exemplary configurable personal washing device including at least one rotating joint permitting reconfiguration of the device, with the device being in a closed, curved state. Personal washing device 10 is illustrated including three portions, a handle portion 20, a central portion 30, and a washing end portion 40. Portions of device 10 can be made with plastic, such as with injection molding or blow molding. Alternatively, portions can be constructed with wood or other known materials. Components of the joints can include metallic fasteners and springs. Handle portion 20 is attached to central portion 30 with a first rotating joint 60. Central portion is attached to washing end portion 40 with a second rotating joint 70.

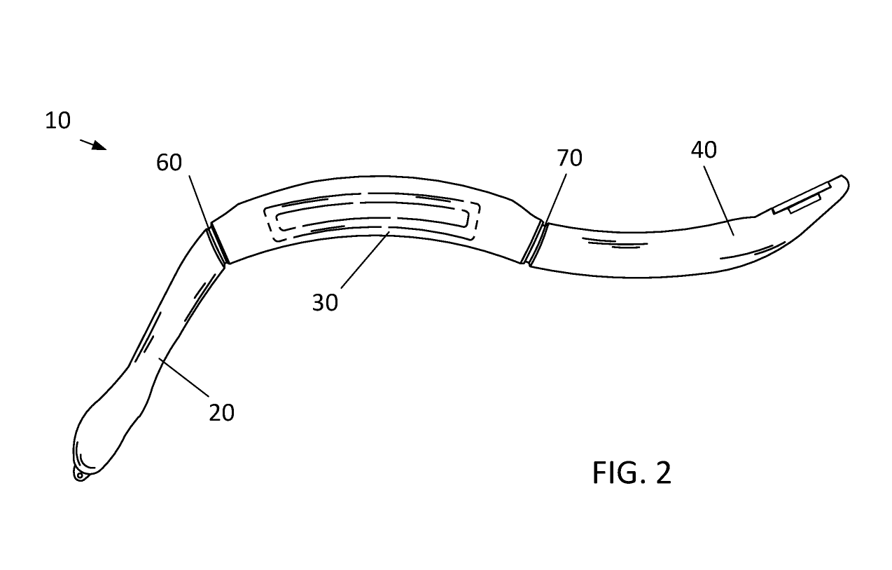

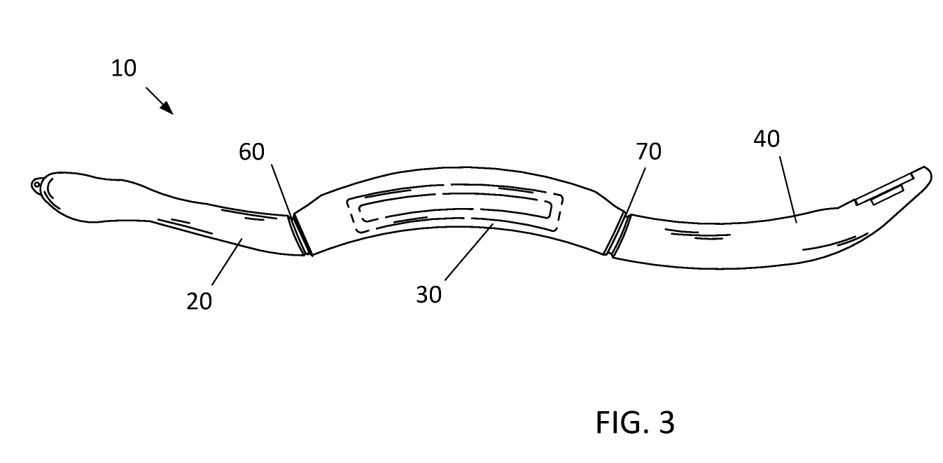

Rotating joints 60 and 70 can be rotated to change states of personal washing device 10. As illustrated in FIG. 1, device 10 can include a closed, curved state. In this curved state, one can hold handle portion 20 in front of their body, permit central portion 30 to rest on a shoulder, and use washing end portion 40 to wash their back. In other states, such as the partially extended state of FIG. 2 or the fully extended state of FIG. 3, one can wash different areas of the body while keeping his or her hands in a relatively normal, in front of the body position.

Rotating joints 60 and 70 need to be able to turn to actuate between the described states. However, detents or locking mechanisms or details can be used to fix personal washing device 10 into fixed positions, so that the device can be used without the joints just spinning freely. Exemplary detent details are illustrated herein. Any number of detents, fixing screws, spring activated locks, slot and groove mechanisms, or similar means known in the art for selectively permitting a rotating joint to spin or be in a fixed orientation can be utilized in the rotating joint or joints of the disclosed device. Similarly, one joint, two joints, or three or more joints can be used in a personal washing device in accordance with the present disclosure. The particular exemplary embodiments of the disclosure are intended to be non-limiting.

FIG. 2 illustrates the personal washing device of FIG. 1, with one of the rotating joints rotated, with the device being in a partially extended state. Personal washing device 10 is illustrated including handle portion 20, central portion 30, and washing end portion 40. Rotating joint 60 is illustrated in a same state as in FIG. 1. Rotating joint 70 in FIG. 2 is illustrated rotated 180 degrees from the illustrated condition in FIG. 1. As a result, instead of personal washing device 10 being in a curved state, central portion 30 and washing end portion 40 are in a substantially straight orientation. In this state, a user could use one hand on handle portion 20 and the other hand on central portion 30, thereby having two handles not in parallel with each other, and use the washing end portion 40 to scrub lower legs or other similar distant parts of the body. It will be appreciated that in another state, device 10 can be illustrated with both joints 60 and 70 reversed 180 degrees from the illustrated conditions of FIG. 2, thereby achieving a second, alternative, partially extended state. A number of alternative washing attachments 50 can be attached to washing end portion 40.

FIG. 3 illustrates the personal washing device of FIG. 1, with both of the rotating joints rotated, with the device being in a fully extended state. Personal washing device 10 is illustrated including handle portion 20, central portion 30, and washing end portion 40. Both rotating joint 60 and rotating joint 70 in FIG. 3 are each illustrated rotated 180 degrees from the illustrated conditions in FIG. 1. As a result, personal washing device 10 is in a substantially straight orientation. In this fully extended state, one can be standing and wash his or her feet.

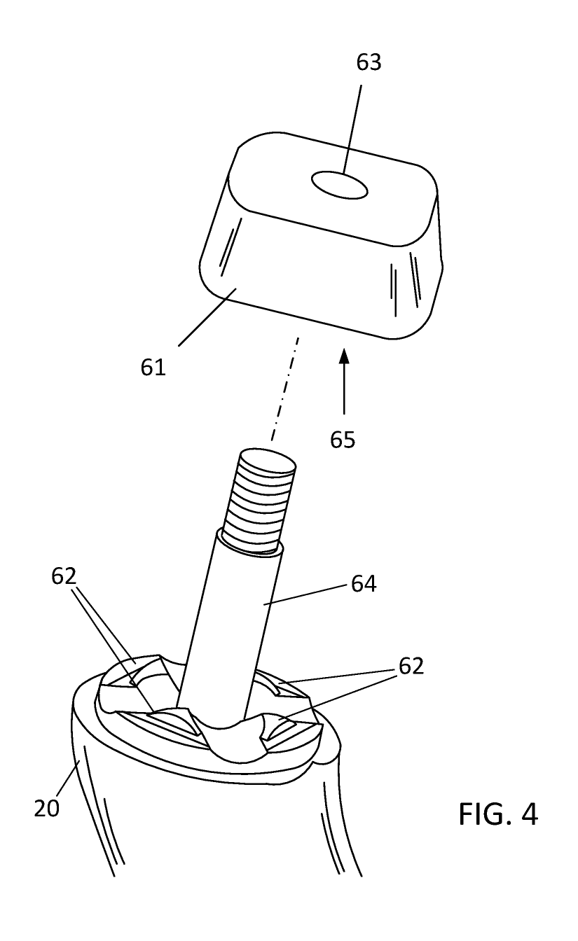

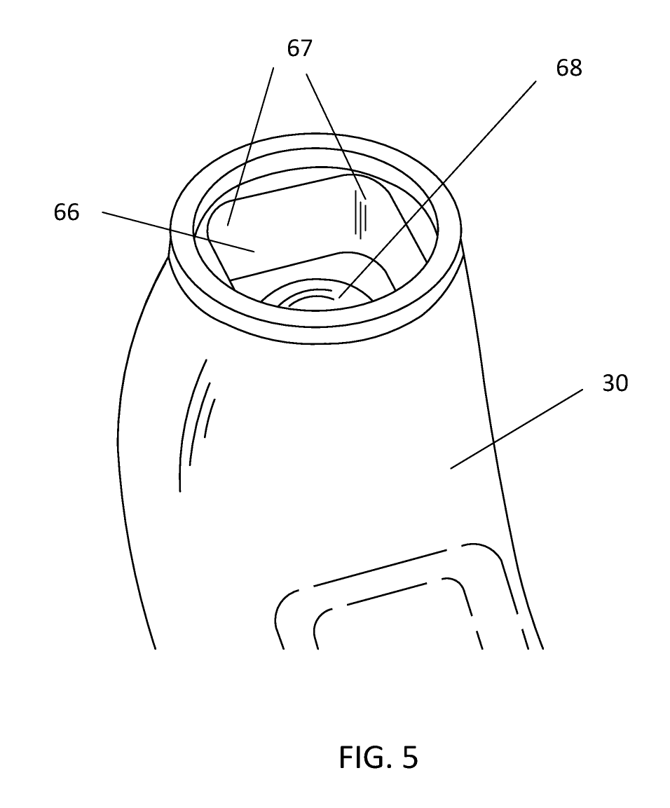

FIGS. 4 and 5 illustrate components of joint 60 in separate, disassembled detail. FIG. 4 illustrates a handle portion of the personal washing device of FIG. 1 in detail, illustrating components of one of the rotating joints. Handle portion 20 is illustrated disassembled from the rest of the personal washing device. A central post 64 is illustrated, including threads useful to affix the central post within mating features of the central portion. Detents 62 are illustrated as raised details on handle portion 20. Mating pockets or depressed details on a mating central portion can permit detents 62 to rest within the mating depressed details, thereby providing an ability to use the device is a fixed state wherein the joints cannot spin freely. An axial spring can be used to press detents 62 into the mating depressed details. Exemplary detents 62 are curved, such that with sufficient torque applied to handle 20 and the neighboring central portion, detents 62 will displace from the mating depressed details such that the device can be made to change from one state to another, such as from the curved state of FIG. 1 to a partially extended state. Depending upon the details of detents 62 and the details of the mating depressed details, two, three, or more fixed orientations of handle portion 20 to the neighboring central portion can be defined. It will be appreciated that a same or similar configuration can be used in the other rotating joint between the central portion and the washing end portion.

An optional depressed details insert 61 is illustrated. For manufacturing purposes, it can be beneficial to create a self-contained insert with depressed details configured to mate with detents 62 of FIG. 4. Insert 61 is a tapered rounded rectangle with a central hole 63 configured to fit over post 64. Additionally, a spiral shaped spring and nut can be fit over the post as is illustrated in FIG. 7, such that pressure is created between insert 61 and detents 62. Face 65 of insert 61 includes mirror image depressed details of detents 62 such that detents 62 can seat against the details of face 65.

FIG. 5 illustrates a central portion of the personal washing device of FIG. 1 in detail, illustrating components of one of the rotating joints. Central portion 30 is illustrated. A first rectangular cavity 66 is illustrated including curved corner portions 67. A second conical cavity 68 is illustrated below cavity 66. Cavity 66 is configured to receive insert 61 of FIG. 4, wherein insert 61 can be glued, adhered, sonically welded, or otherwise fixed within cavity 66. Post 64, the attached spiral shaped spring and nut, can fit within cavity 68. In this way, a pre-assembled handle portion 20, insert 61, and spiral shaped spring and nut can be fit within cavities 66 and 68, adhered in place, and the joint can be complete and ready for use. In another embodiment, an access door or snapping cover feature can be formed in central portion 30, permitting one to access an area behind or under cavity 68, to enable assembly of the post 64, a spiral shaped spring, and a nut to the illustrated joint details, thereby completing assembly of device 10. Use of such a door would eliminate a need for insert 61, for example, with depressed details mating with detents 62 being able to be formed right in the central portion 30 and also permitting the spring and nut to be assembled to post 64 through the open door. It will be appreciated that the joint details of FIGS. 4 and 5 could be reversed, for example, with the post being formed upon central portion 30 and with the cavities and mating details being formed in handle portion 20.

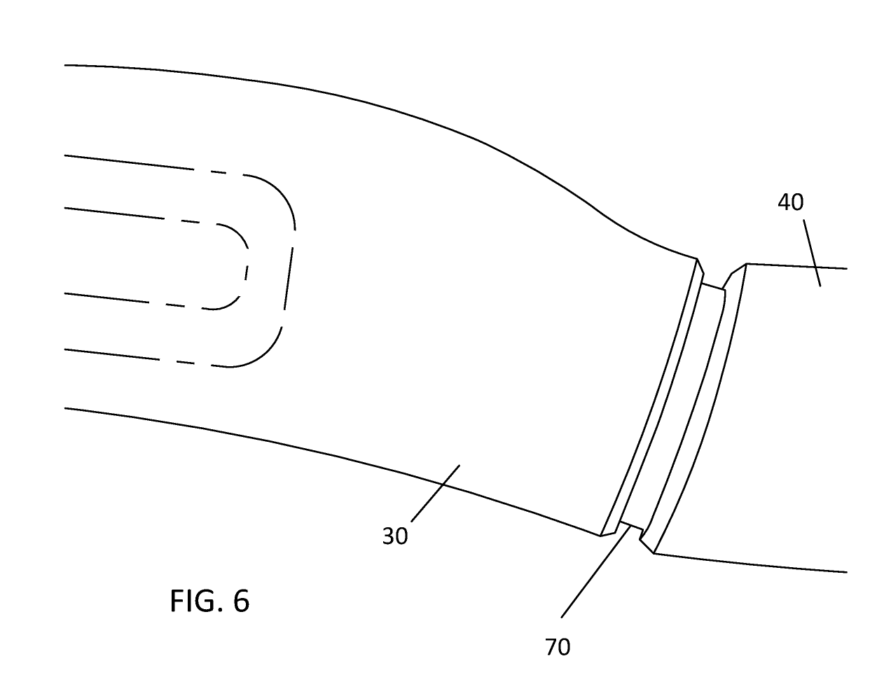

FIG. 6 illustrates the central portion, a washing end portion, and a rotating joint there between of the personal washing device of FIG. 1. Central portion 30 and washing end portion 40 are illustrated connected with rotating joint 70. FIG. 7 illustrates the central portion, washing end portion, and rotating joint of FIG. 6 in cross section, showing internal details of the rotating joint. Central portion 30 and washing end portion 40 are illustrated connected with rotating joint 70. Washing end portion 40 is similar to the handle portion 20 of FIG. 4, with central post 74 and detents 72 being formed unitarily there upon. Central post 74 and detents 72 are mated first with insert 71, similar to insert 61 of FIG. 4, and are subsequently inserted within a cavity in central portion 30 and insert 71 is adhered or affixed therein. Detents 72 and depressed details 78 of insert 71 are illustrated nested together. Spiral shaped spring 82 is positioned upon central post 74 and a nut 84 is provided upon the threaded end portion of central post 74, such that spring 82 is compressed between nut 84 and insert 71. This compression of spring 82, with the spring force acting upon nut 84, causes detents 72 to be forced against mating depressed details 78 formed upon insert 71. By applying torque to the device, the spring force can be overcome, details 72 will displace from the mating depressed details 78, and the washing end portion 40 can be turned relative to central portion 30. It will be appreciated that the joint details of central portion 30 and washing end 40 can be reversed in accordance with alternative embodiments of the disclosure.

It will be appreciated that in an alternative embodiment, an optional access door can be formed in central portion 30 and that insert 71 can be omitted. It will further be appreciated that depressed details 72 can be formed integrally upon central portion 30.

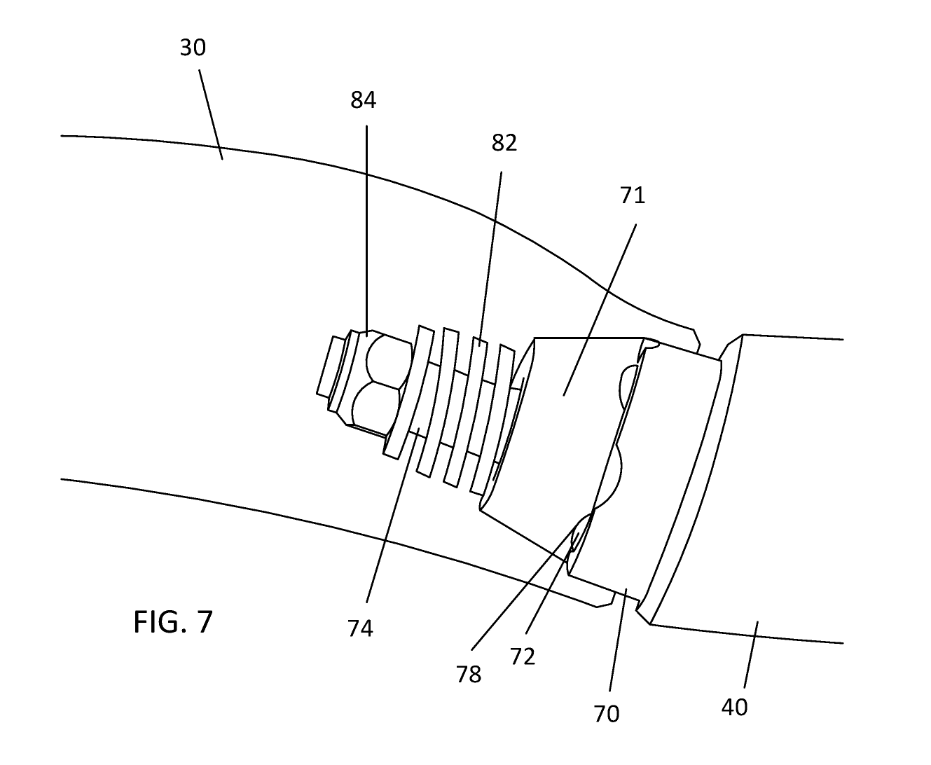

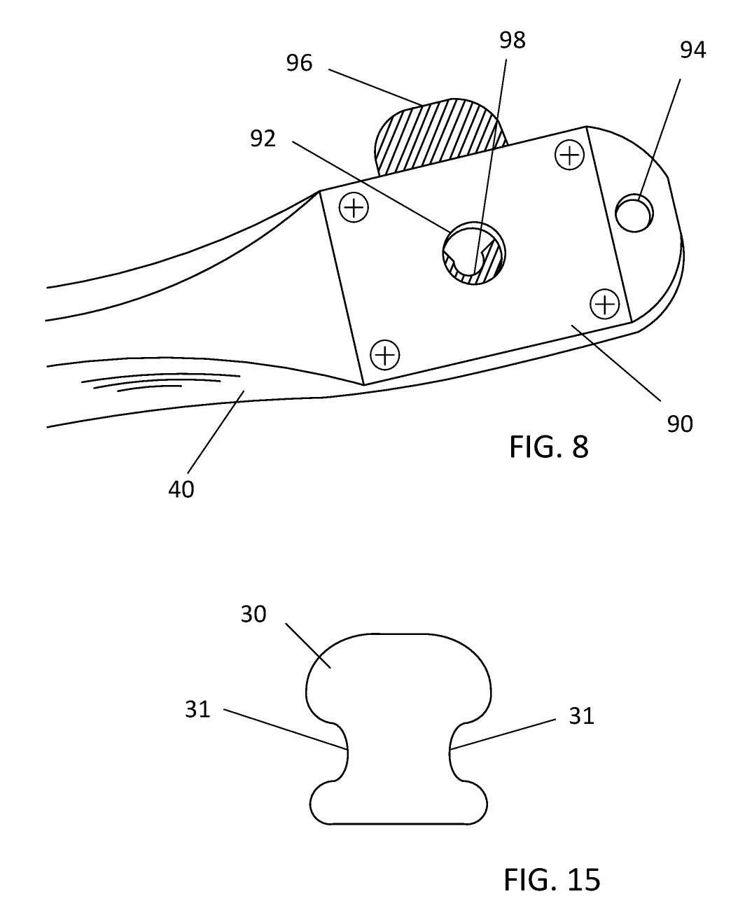

FIG. 8 illustrates an exemplary attachment end of the washing end portion, including a spring loaded attachment feature configured to selectively attach a washing attachment to the washing end portion. Washing end portion 40 is illustrated including attachment end 90. Attachment end 90 includes a first receiving cavity 92 including a spring loaded catch detail 98 which can be configured to hold a notched post of a washing attachment and a second receiving cavity 94. Button 96 is illustrated attached to spring loaded catch detail 98. Depression of button 96 can disengage spring loaded catch detail 98 from a mating notched post, thereby permitting disengagement of the attached washing attachment from attachment end 90. Second receiving cavity 94 can be a simple cylindrically shaped cavity configured to receive a mating simple cylindrically shaped post. Together, cavities 92 and 94 engage and affix a washing attachment to attachment end 90 and stop the washing attachment from rotating relative to attachment end 90.

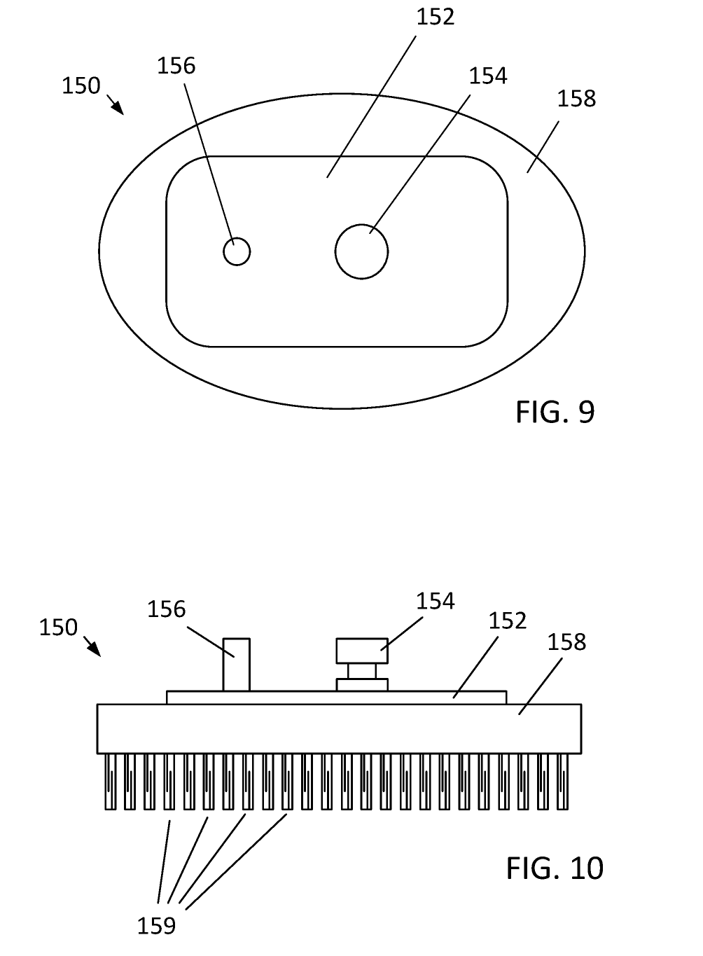

FIGS. 9 and 10 illustrate a first exemplary washing attachment that can be attached to the personal washing device of FIG. 1, the attachment including a washing brush. Brush attachment 150 is illustrated including mounting plate 152 and brush head 158. Mounting plate 152 includes a notched post 154 and simple post 156. Notched post 154 and simple post 156 are configured to be attached to the cavities illustrated in FIG. 8. Bristles 159 are attached to and protrude from brush head 158. Brush attachment 150 is exemplary, a number of different brush designs are envisioned, and the disclosure is not intended to be limited to the particular example provided herein.

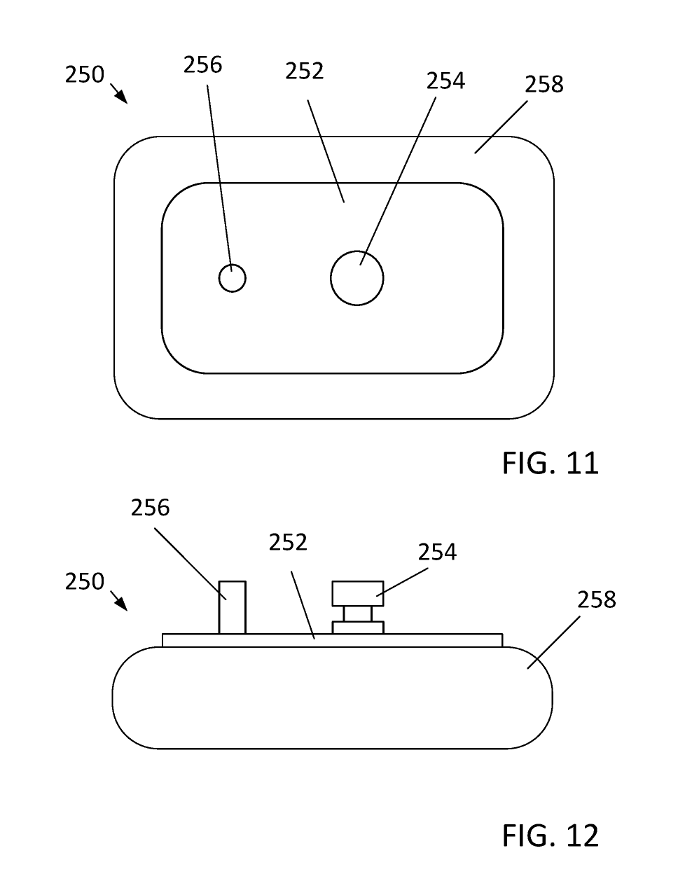

FIGS. 11 and 12 illustrate a second exemplary washing attachment that can be attached to the personal washing device of FIG. 1, the attachment including a lotion dispenser. Lotion dispenser 250 is illustrated including mounting plate 252 and lotion reservoir 258. Mounting plate 252 includes a notched post 254 and simple post 256. Notched post 254 and simple post 256 are configured to be attached to the cavities illustrated in FIG. 8. Lotion reservoir 258 can include any shape or size, and features of mounting plate 252 can be created within lotion reservoir 258 to permit attachment of the bar to the plate. Lotion dispenser 258 can include small holes or a pressure sensitive valve useful for selectively dispensing lotion when the attachment is pressed against skin of the user. Lotion dispenser 250 is exemplary, a number of different lotion dispensing designs are envisioned, and the disclosure is not intended to be limited to the particular example provided herein.

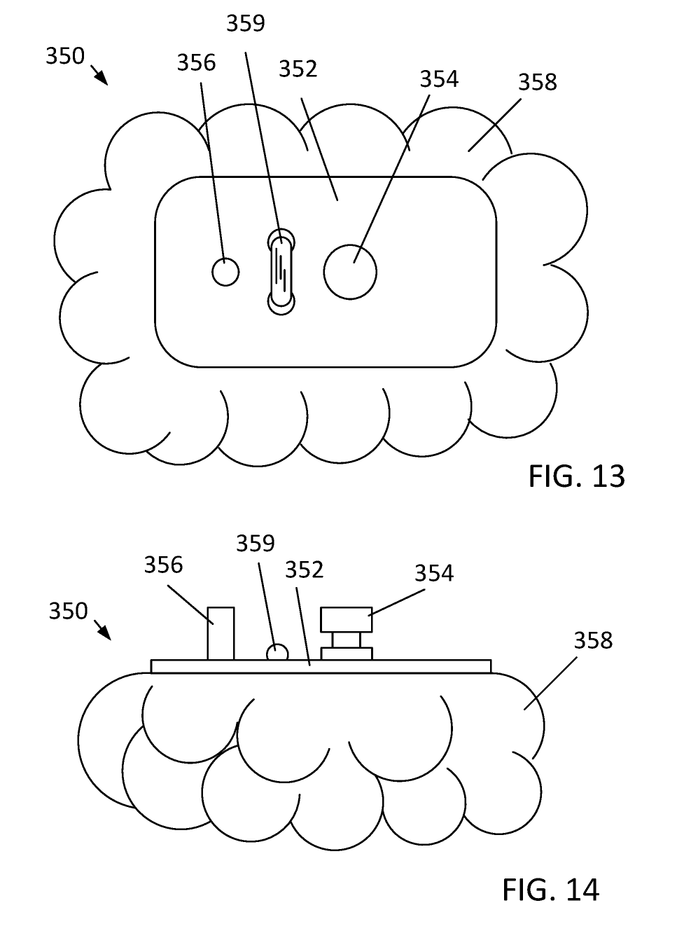

FIGS. 13 and 14 illustrate a third exemplary washing attachment that can be attached to the personal washing device of FIG. 1, the attachment including a scrubbing loofah. Scrubbing loofahs can include rough cloth, nylon netting fabric, sponges, or any other skin cleansing materials known in the art. Loofah attachment 350 is illustrated including mounting plate 352 and loofah head 358. Mounting plate 352 includes a notched post 354 and simple post 356. Notched post 354 and simple post 356 are configured to be attached to the cavities illustrated in FIG. 8. Loofah details of loofah head 358 will vary depending upon the loofah materials utilized. Loofah attachment 350 is exemplary, a number of different brush designs are envisioned, and the disclosure is not intended to be limited to the particular example provided herein.

FIG. 15 illustrates the central portion in cross section, illustrating optional gripping depressions formed in sides of the central portion. Central portion 30 is illustrated including two gripping depressions 31, one on either lateral side of the central portion 30. It will be appreciated that any number of textured, grooved, or imprinted patterns could optionally be placed upon handle portion 20, central portion 30, and/or washing end 40 to make the device ergonomically pleasing to a user.

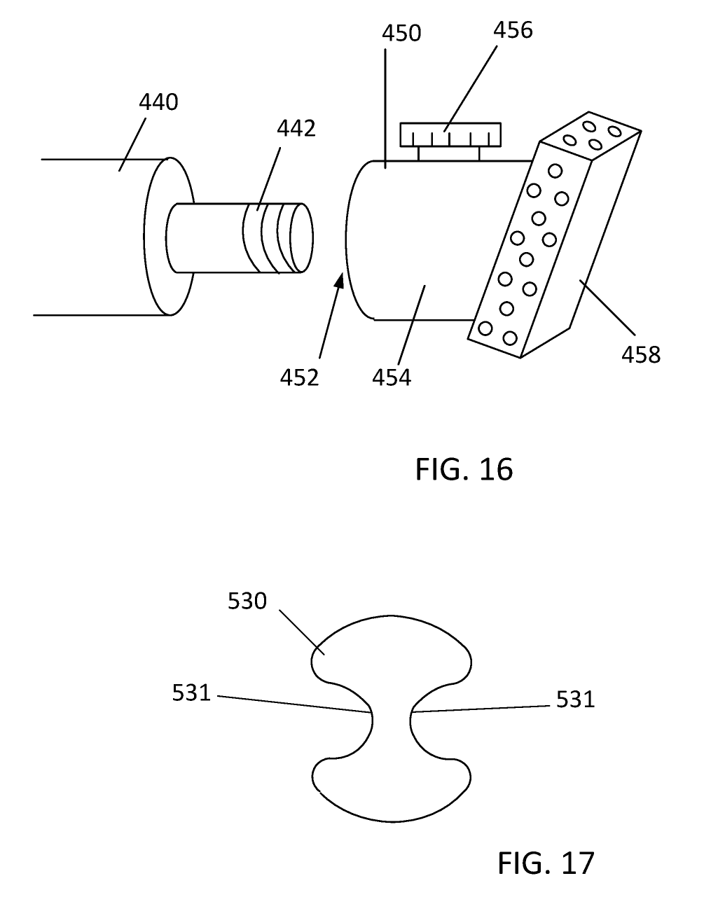

A number of different washing end portions are envisioned, in particular, with different mechanisms for attaching a washing attachment thereto. For example, FIG. 16 illustrates an exemplary alternative washing end portion, including washing end portion 440 including a threaded washing attachment connector 442. A mating threaded cavity can be formed upon an exemplary brush attachment for use with the disclosed personal washing device. FIG. 16 further illustrates an exemplary screw-on washing attachment 450 embodied as a sponge 458 with a liquid soap reservoir 454. Face 452 includes a female threaded fastening cavity configured to matingly attach to connector 442. Cap 456 is used to fill reservoir 454 with liquid soap.

FIG. 17 illustrates an alternative exemplary embodiment of the central portion. Central portion 530 includes gripping depressions 531. The illustrated configuration can be advantageous when making the central portion with a blow molding process.

Washing attachments are shown herein as optional, interchangeable end features of the device. It will be appreciated that any of these attachments can instead be provided as a permanently affixed end to the otherwise adjustable device disclosed herein.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus, comprising:
a configurable personal washing device comprising:
a central portion;
a handle portion;
a washing end portion;
a first rotating joint connecting the central portion to the handle portion; and
a second rotating joint connecting the central portion to the washing end portion;
wherein the first rotating joint and the second rotating joint are configured to permit selection between a first, curved state, a second partially extended state, and a third, fully extended state.

2. The apparatus of claim 1, wherein the first rotating joint is spring loaded and includes detent features configured to lock the central portion and the handle portion into a plurality of selectable orientations.

3. The apparatus of claim 1, wherein the first rotating joint is spring loaded and includes detent features configured to lock the central portion and the washing end portion into a plurality of selectable orientations.

4. The apparatus of claim 1, wherein the washing end portion comprises a cavity comprising a spring loaded catch.

5. The apparatus of claim 4, wherein the washing end portion further comprises a second cavity.

6. The apparatus of claim 1, further comprising a washing attachment comprising a brush attachment.

7. The apparatus of claim 1, further comprising a washing attachment comprising a lotion dispensing attachment.

8. The apparatus of claim 1, further comprising a washing attachment comprising a loofah attachment.

9. The apparatus of claim 1, wherein the washing end portion comprises a threaded washing attachment connector.
